(19) United States
(12) Patent Application Publication
(10) Pub. No.: US 2016/0277451 A1
(43) Pub. Date: Sep. 22, 2016

(54) SMALL-CAPACITY IMS CORE SYSTEM

(71) Applicant: CORE TREE CO., LTD, Yuseong-gu, Daejeon (KR)

(72) Inventors: Jong Woo HAN, Gyeonggi-do (KR); Seung Gon KIM, Gyeonggi-do (KR)

(73) Assignee: Core Tree Co., Ltd., Daejeon (KR)

(21) Appl. No.: 14/375,492

(22) PCT Filed: Nov. 20, 2013
(86) PCT No.: PCT/KR2013/010558

§ 371 Date: Jul. 30, 2014

(51) Int. Cl. H04L 29/06; H04M 7/00; H04L 5/14

(52) U.S. Cl. CPC H04L 65/1016; H04L 65/103; H04L 65/104; H04L 5/14; H04M 7/0069

(57) ABSTRACT

A small-capacity IMS core is a system that provides support so that a group customer using an IMS service can manage a POTS system and an Internet telephone system in parallel and can manage a non-IMS terminal. This system includes a main control unit (MCU) configured to provide only functions that belong to the functions of an MCU IMS structure and that are required for a group customer, a line interface unit (LIU) configured to be used to extend physical ports of the MCU and a POTS, a SIP gateway configured to convert a standard SIP message into an IMS message, and an FMC controller configured to provide support in order to enable a wireless terminal, such as a wireless IMS terminal/smartphone, to be used in a mobile environment. This system includes an IP communication-based virtual Ethernet back-plane so that the units can exchange information at high speed.

### TECHNICAL FIELD

The present invention relates to a small-capacity IMS core system that is applicable to a group customer.

### BACKGROUND ART

In general, an IMS (IP multi-media subsystem) is a service platform that provides multimedia services, such as voice, audio, video and data services, based on the Internet protocol (IP). Although an IMS was proposed by 3GPP (the 3rd Generation Partnership Project) in order to support multimedia services over a 3G mobile communication network, the IMS is being currently and widely employed by IPTV and wired telephony service providers.

3GPP is a collaborative research project among mobile communication-related groups that was conducted within the scope of the IMT-2000 Project conducted by the International Telecommunication Union (ITU), aimed to establish 3rd mobile communication system specifications applicable throughout the world, and also aimed to standardize radio, a core network and a service architecture based on the GSM standard that was chiefly used by European countries.

A standardization project corresponding to 3GPP includes 3GPP2 (the 3rd Generation Partnership Project 2), and 3GPP2 has standardized a 3rd technology based on IS-95 CDMA known as CDMA2000.

3GPP has conducted standardization on a per-Release basis since its establishment. In “Release 5” published in 2002, the IMS was first introduced. The IMS is not a communication specification adapted to exchange information but a service architecture adapted to provide various multimedia services via a single platform. Protocols called SIP and Diameter are used for the exchange of information between actual systems.

After 3GPP has introduced the IMS, 3GPP2, ITI-T, ETSI, ATIS, MSF and CablelLabs have defined service architectures, such as “NGN,” “TISPAN” and “PacketCable 2.0,” based on the IMS and have added the requirements of each service, and, thus, the IMS may be considered to be the only standard that is used in all the fields of wired/wireless communication and broadcasting.

Currently, the IMS has been adopted in a mobile telephony service network, and has been used to provide multimedia services and Internet services in a mobile communication environment. Enterprises are burdened by eliminating an existing communication infrastructure in which an enormous cost has been invested and then introducing new IMS terminals. Furthermore, high costs are incurred in newly deploying LAN cables in factories or conference rooms that are not equipped with an IP environment. Therefore, for enterprises that desire to gradually introduce IMS services while maximally using an existing communication infrastructure, there is a need for the development of a new type of communication system.

### DISCLOSURE

### Technical Problem

Accordingly, the present invention has been made keeping in mind the above problems occurring in the prior art, and an object of the present invention is to provide a small-capacity IMS core system that is suitable for the construction of an IMS solution for an enterprise having 1,000 or less employees or a small-sized multimedia service provider.

Another object of the present invention is to be located between an IMS terminal and a Call Session Control Function (CSCF) while operating in cooperation with the IMS service of a key communication service provider, and to provide a CSCF function to the IMS terminal and the function of the IMS terminal to the CSCF.

A further object of the present invention is to enable the cooperative operation of terminals that are currently used in an enterprise, such as a wired telephone and an SIP phone, using a gateway, to enable cooperative operation with an external telephone over a PSTN when the IMS service of a key communication service provider is not used, and to provide an IMS service only to an extension telephone or multimedia service subscriber.

Yet another object of the present invention is to provide an SIP-Gateway function for cooperative operation with an SIP-based Internet telephony service, thereby enabling cooperative operation with an SIP-based soft switch and a standard SIP phone.

Still another object of the present invention is to provide a private branch exchange function for an enterprise because an IMS or a PSTN may be selected and then a call can be placed and received.

Still another object of the present invention is to provide the mutual backup function of a telephony service, thereby making a detour to a PSTN when an IMS service fails and also making a detour to an IMS when a PSTN fails.

Still another object of the present invention is to assign an extension number to an external IMS terminal or an SIP terminal, thereby providing an inter-extension terminal free communication/SMS service.

Still another object of the present invention is to provide an SIP-IMS protocol conversion function for the use of an existing SIP terminal because a standard SIP terminal can be supported.

Still another object of the present invention is to provide a voice roaming function between a wireless LAN network and a 3G/4G network using an FMC-controller function because mobile VoIP can be supported.

### Technical Solution

In order to achieve the above objects, the present invention provides an IMS core system, including a main control unit (MCU) configured as a terminal device that uses services while operating in cooperation with an IMS service provider network including an Internet telephony network and an IPTV network, and configured to include an IMS core, including a CSCF, an MGW and an ABGF, and the function of an IMS terminal; the IMS core system further including any one of an line interface unit (LIU) configured to include ports that enable cooperative operation with a POTS system including T1/E1 PRI, FXO and FXS; an SIP gateway configured to include a protocol conversion function in order to enable an SIP terminal, including a SIP phone, a soft phone, a WiFi phone and a DECT phone, to operate in cooperation with an IMS apparatus without a change to SIP terminals, including a SIP phone, a soft phone, a WiFi phone and a DECT phone, or a change to firmware; and an FMC controller configured to include a roaming function for enabling an IMS service to be used in a mobile environment, and to include the IP address synchronization function of a mobile terminal.

In a preferred embodiment of the present invention, units, including the MCU, the LIU, the SIP gateway and the FMC controller, are provided; IP communication is performed between the units at high speed; and a control bus configured to detect the attachment and detachment of each of the units and control the operations of the respective units, an IO interface configured to provide sub-rack information and slot address information as information about locations at which the respective units have been attached, and a back-plane provided to automatically detect a 10/100/1000 Mbps Ethernet speed and a half/full duplex mode for each slot and enable the exchange of information between the units, including the MCU, the LIU, the SIP gateway and the FMC controller, using a non-blocking method are further included.

### Advantageous Effects

The small-capacity IMS core system according to the present invention, which is configured described above, has an excellent advantage of being suitable for the construction of an IMS solution for a group customer (an enterprise, an organization, or a school) well equipped with an existing communication infrastructure, such as a small-sized enterprise, a small-sized multimedia service provider, or the like.

The present invention has another advantage of, when an IMS service is introduced, enabling partial or full introduction while maximally utilizing an existing system, thereby minimizing introduction costs.

The present invention has still another advantage of increasing the reliability and stability of a communication service because PSTN backup and FMC functions that are not provided by an IMS service are also provided.

The present invention has yet another advantage of enabling an application solution capable of increasing work efficiency, such as Mobile Office, SmartWork, UC, etc., to be smoothly introduced.

### DESCRIPTION OF DRAWINGS

FIG. 1 is a diagram illustrating an example of the configuration of an IMS that can be implemented in the present invention;

FIG. 2 is a diagram illustrating an example of the functions of an IMS core system according to the present invention;

FIG. 3 illustrates an example of the connection configuration of the IMS core system according to the present invention;

FIG. 4 is a diagram illustrating an example of the coupling configuration of the IMS core system according to the present invention;

FIG. 5 is a diagram illustrating an example of an embodiment of the IMS core system according to the present invention;

FIG. 6 is a diagram illustrating an example of the unit configuration of the IMS core system according to the present invention;

FIG. 7 is a diagram illustrating an example of the hierarchical structure of the MCU of the IMS core system according to the present invention;

FIG. 8 is a diagram illustrating an example of the hierarchical structure of the LIU of the IMS core system according to the present invention;

FIG. 9 is a diagram illustrating an example of the hierarchical structure of the SIP gateway of the IMS core system according to the present invention;

FIG. 10 diagram illustrating an example of the hierarchical structure of the FMC controller of the IMS core system according to the present invention;

FIG. 11 is a diagram illustrating an example of the hierarchical structure of the MCU with a focus on the function of the IMS core system according to the present invention;

FIG. 12 is a diagram illustrating an example of the hierarchical structure of the LIU with a focus on the function of the IMS core system according to the present invention;

FIG. 13 is a diagram illustrating an example of the hierarchical structure of the SIP gateway with the function of the IMS core system according to the present invention; and

FIG. 14 is a diagram illustrating an example of the hierarchical structure of the FMC controller IMS with a focus on the function of the core system according to the present invention.

### MODE FOR INVENTION

A detailed description will be given with reference to the accompanying drawings.

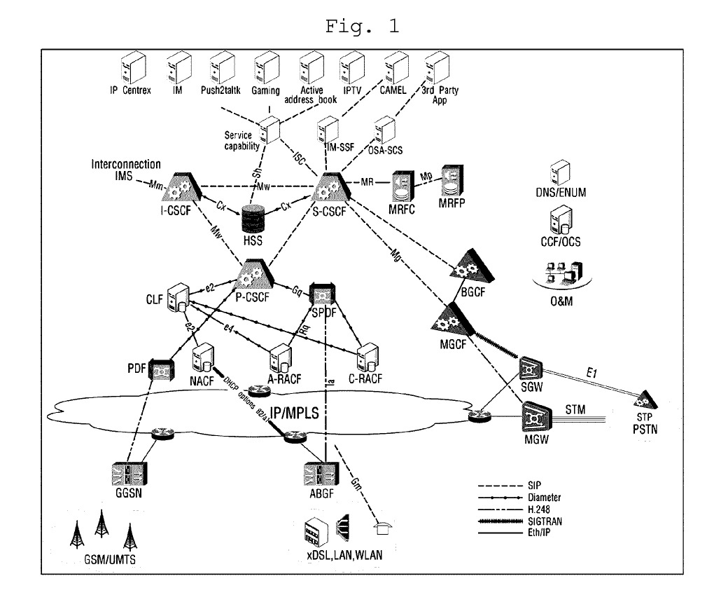

That is, a small-capacity IMS core system 100 according to the present invention is an IMS service system that is configured to include a main control unit (MCU) 110, a line interface unit (LIU) 120, an SIP gateway 130, and an FMC controller 140, as illustrated in FIGS. 1 to 10.

In the small-capacity IMS core system 100, a plurality of processing units or the terminals of control configurations are connected via an IP means, and the MCU 110 is provided for the communication configurations and control of the terminals. That is, the MCU 110 is a terminal device using an IMS service while operating in cooperation with an IMS service provider network, including an Internet telephony network and an IPTV network, and includes IMS core functions, including a CSCF, an MGW and an ABGF, and the function of an IMS terminal. Based on other automatic settings, the state settings of the units of the individual terminals and information processing and control related to firmware are performed.

That is, the MCU 110 assists a group customer (an enterprise, an organization, a school, or the like) using an IMS service to internally manage both a POTS system and an Internet telephone system and to use non-IMS terminals, such as a wired/wireless IP telephone and a smartphone, together with IMS terminals, and simply provides only functions that belong to the functions of the IMS structure and that are required for the group customer.

Furthermore, an LIU (line interface unit) 120 configured to include ports operating in cooperation with a POTS system including T1/E1 PRI, FXO and FXS, and to be used for the extension of the physical port of a wired telephone; a SIP gateway 130 configured to include a protocol conversion function in order to enable cooperative operation with the IMS apparatus without a change to SIP terminals, including a SIP phone, a soft phone, a WiFi phone and a DECT phone, or a change to firmware, and configured to convert a standard SIP message into an IMS message; and an FMC controller 140 configured to include a roaming function for using an IMS service in a mobile environment and the IP address synchronization function of a mobile terminal are further included. That is, the FMC controller supports wireless terminals, such as a wireless IMS terminal and a smartphone, so that the wireless terminals can be used in a mobile environment like internal terminals.

Furthermore, units including the MCU, the LIU, the SIP gateway, the FMC controller and a unit interface are provided. A configuration in which IP communication between the individual units is performed at high speed is provided. In particular, the present invention is configured to include a control bus configured to perform the detection of the coupling and separation of individual units and the control of the units; an IO interface configured to provide sub-rack information and slot address information to the location information of the coupling of the individual units; and a back-plane provided to automatically detect a 10/100/1000 Mbps Ethernet speed and half/full duplex mode for each slot, and to exchange information between the units including the MCU, the LIU, the SIP gateway and the FMC controller using a non-blocking method via IP communication. That is, the back-plane forms an IP communication basis so that the units exchange information at high speed, or may be implemented as a virtual Ethernet back-plane.

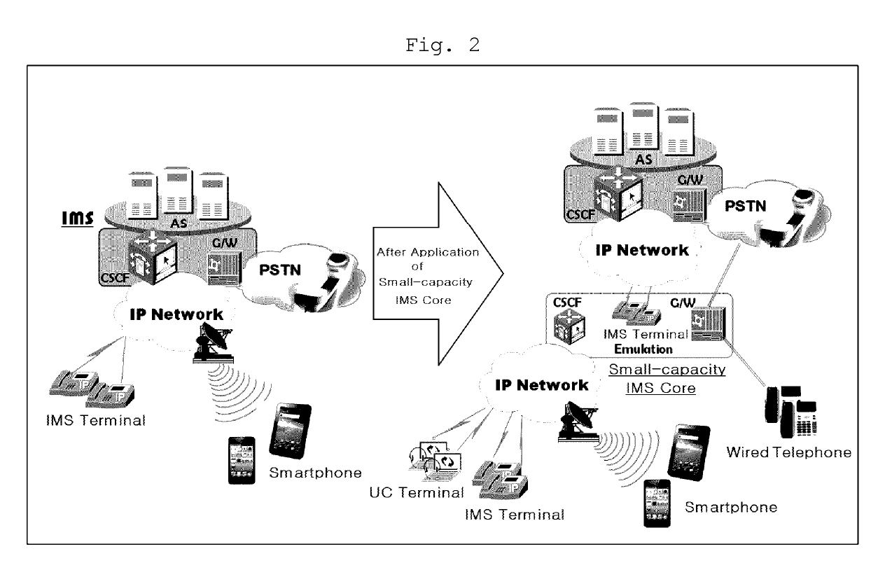

FIG. 1 is a diagram illustrating an example of the configuration of an IMS that is implemented via the small-capacity IMS core system 100 according to the present invention, and FIG. 2 is a schematic diagram of IMS functions that are performed by the small-capacity IMS core system 100 according to the present invention.

The roles of the principal functions of an IMS service that are performed in the small-capacity IMS core system 100 according to the present invention are described with reference to FIG. 1, as follows:
IM-SSP, OSA-SCS, and service capability: An application server that provides a service while communicating with an S-CSCF.
HSS (Home Subscriber Server): A database that provides subscriber information to an entity or the like that directly performs call processing in an IMS network, and performs subscriber authentication and authorization functions and provides the current physical location of a subscriber.
CSCF (Call Session Control Function): The processing of a multimedia call of a subscriber (the role of a SIP server or a proxy). Depending on the type of service, the CSCF performs SIP routing to an AS, and also performs non-SIP service processing for a TDM-based user.
MRF (Media Resource Function): The provision of functions of voice manipulation, such as voice stream mixing, tone, announcement transmission, etc. The MRF may be divided into an MRFC controller and an MRFP processor.
BGCF (Break Gateway Control Function): A SIP Server that provides a routing service based on a telephone directory. The BGCF is used only when the IMS makes a telephone call to a CS network, such as a PSTN.
MGCF (Media Gateway Controller Function): The MGCF performs call control protocol conversion between SIP and ISUP, and operates in cooperation with an SGW using SCTP (the Streaming Control Transmission Protocol).
SGW (Signaling Gateway): Operation in cooperation with the signaling plane of the CS network. The performance of the conversion between SCTP (the IP protocol) and MTP (the Message Transfer Part, SS7 protocol).
MGW (Media Gateway): The performance of the conversion between RTP (real-time transport protocol) and PCM while operating in cooperation with the media plane of the CS network.
PDF (Policy Decision Function): The performance of policy control and bandwidth management.
SPDF (Service Policy Decision Function): The performance of a PDF function over a wired network. Added by a TISPAN.
CLF (Connectivity Session Location and Repository Function): A dynamic database that stores the profile of a user. The storage of the number of simultaneous sessions allowed, a media type, and location information.
NACF (Network Access Configuration Function): The provision of an enhanced DHCP server function.
A-RACF (Access-Resource and Admission Control Function): The provision of the function of collecting the data of a CLF and calculating the state of an access network. Whether to admit a new session is determined based on this numerical value.
C-RACF (Core-Resource and Admission Control Function): The provision of an RACF function to a core network.
GGSN (Gateway GPRS Support Node): The performance of the cooperative operation between a GPRS backbone network and an external packet data network. The performance of the conversion between an IP address and a GSM address.
ABGF (Access Board Gateway Function): The provision of a firewall and a NAT traversal function.

Furthermore, as illustrated in FIG. 2, the small-capacity IMS core is located between IMS terminals and the call session control function (CSCF) while operating in cooperation with the IMS service of a key communication service provider, and provides a CSCF function to the IMS terminals and the function of the IMS terminal to the CSCF. A terminal, such as a wired telephone or a SIP phone, which has been used in an enterprise is connected via a gateway. Furthermore, when the IMS service of a key communication service provider is not used, it may be possible to connect to external telephones via a PSTN and to apply an IMS service only to an extension telephone or a multimedia service subscriber.

The small-capacity IMS core system of the present invention can be used in a country that does not provide an IMS service because it is used for the use of an IMS service for an enterprise and has its own call processing functions, such as a CSCF and an MGW. A SIP-gateway function for cooperative operation with a SIP-based Internet telephony service is provided and, thus, an SIP-based soft switch and a standard SIP phone perform cooperative operation.

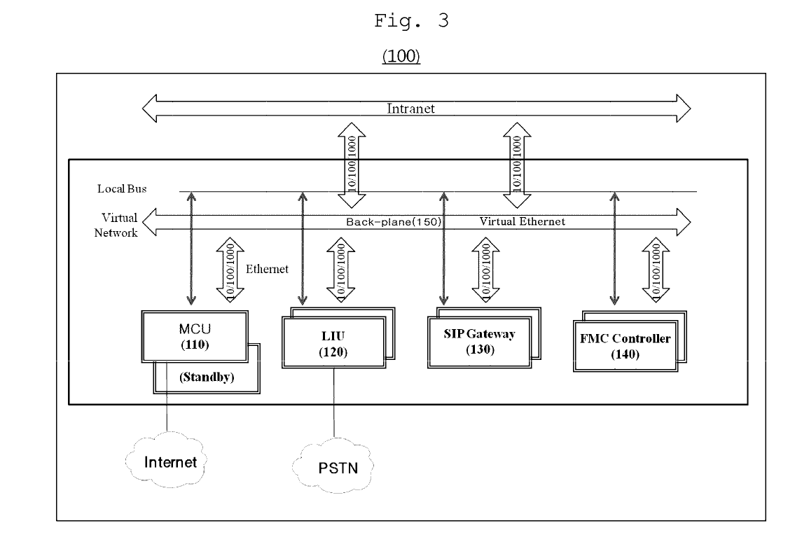

The small-capacity IMS core system 100 according to the present invention, which is provided as described above, is configured such that the units, including the SCU, the MCU, the LIU, the SIP gateway and the FMC controller, and unit interfaces are provided in the back-plane 150, as illustrated in the accompanying drawings. A plurality of terminals configured to perform respective functions is connected via the units, and performs the operation of the IMS system. The small-capacity IMS core system 100 according to the present invention is described in greater detail using preferred embodiments of connection configurations illustrated in FIGS. 3 to 6.

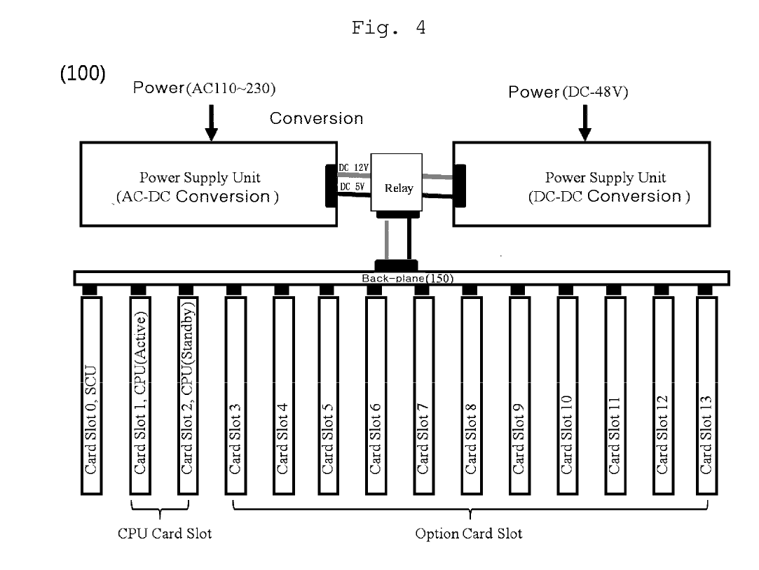

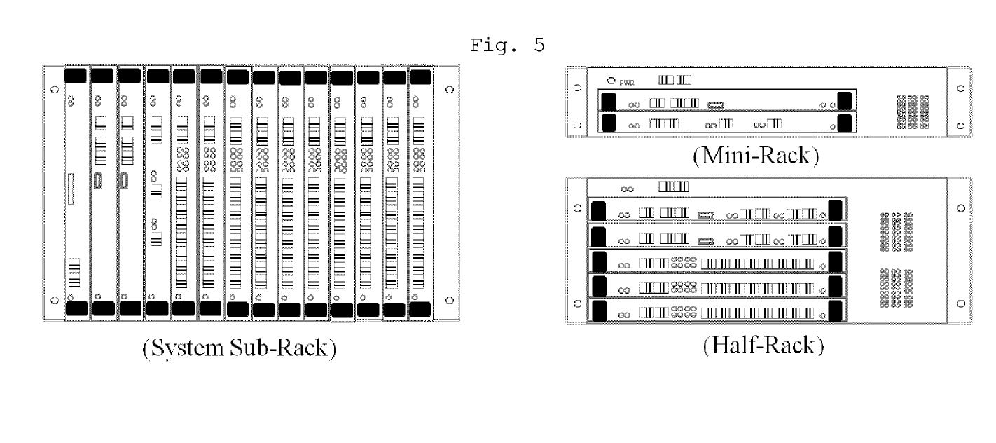

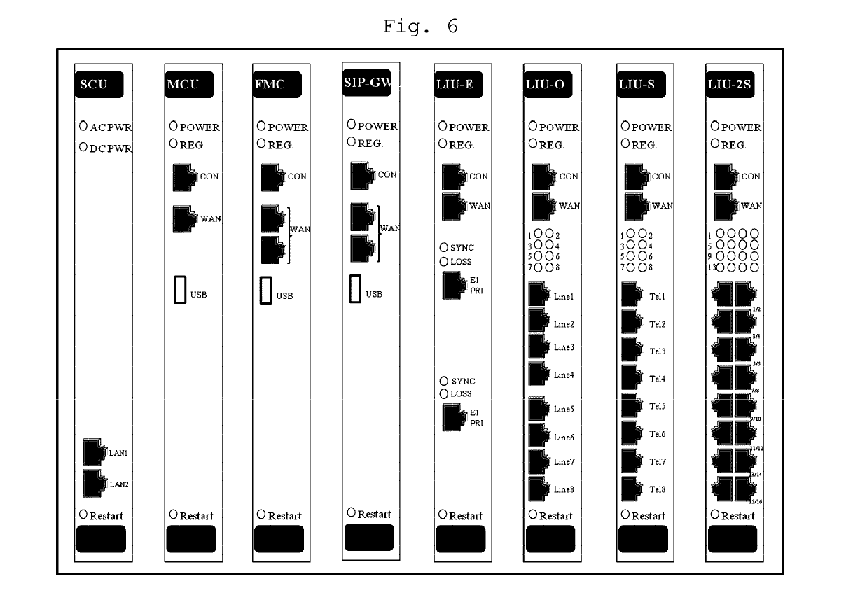

FIG. 3 illustrates an example of the connection configuration of the IMS core system according to the present invention; FIG. 4 is a diagram illustrating an example of the coupling configuration of the IMS core system according to the present invention; FIG. 5 is a diagram illustrating an example of an embodiment of the IMS core system according to the present invention; and FIG. 6 is a diagram illustrating an example of the unit configuration of the IMS core system according to the present invention.

The small-capacity IMS core system 100 according to the present invention, which is provided, as illustrated in FIGS. 1 and 2, is configured such that the units, including the SCU, the MCU, the LIU, the SIP gateway and the FMC controller, and unit interfaces are provided in the back-plane 150, as illustrated in FIGS. 3 to 6. A plurality of terminals configured to perform respective functions is connected via the units, and performs the operation of the IMS system.

The back-plane of the IMS core system supports network ports that connect a plurality of IP terminals connected to an external network switch via the back-plane. Accordingly, examples of IP terminals are a plurality of terminals, such as the MCU, the LIU, the SIP gateway, and the FMC controller, connected via a plurality of ports. Various types of terminals are connected, as illustrated in FIGS. 1 and 2. Furthermore, these IP terminals are connected to the MCU, the LIU, the SIP gateway and the FMC controller, and the MCU, the LIU, the SIP gateway and the FMC controller are implemented to be connected to internal IP addresses.

Accordingly, the IP terminals using internal IP addresses are implemented to connect directly to the back-plane using private IP addresses without the intervention of the WAN port of the MCU, and perform IP communication with the MCU, the LIU, the SIP gateway and the FMC controller.

Furthermore, two private IP addresses are allocated to each unit of the small-capacity IMS core system. For example, the two private IP addresses include one hidden private IP address and one disclosed IP address. Hidden private IP addresses are provided to be used to construct a virtual Ethernet network between the units, while disclosed IP addresses are provided to be used when external IP terminals directly connect to the individual units via an external network connection port of the back-plane.

Furthermore, once each unit has been inserted into a slot of the small-capacity IMS core system and then booting has been performed, an automatic opening process of reading the location information of a slot from the back-plane and setting automatically its own IP address is performed, thereby configuring a network including the individual units.

Furthermore, after each unit has been included in the configuration of the network, the unit accesses the MCU, and compares a firmware version stored in the storage of the MCU with its own firmware version. An automatic upgrade method of, if the above firmware versions are different from each other, performing an upgrade with the firmware stored in the MCU and reading the unit's own detailed configuration information from the DB of the MCU, thereby performing the procedure of performing automatic function settings, is implemented.

As described above, after each unit has been inserted into a slot of the small-capacity IMS core system and then has been activated, the automatic opening process and the automatic upgrade method are performed, so that the operation of individual devices is automatically performed and managed and the use thereof is further facilitated.

A specific configuration for the above operation is described using a preferred example of FIGS. 3 to 6. First, FIG. 3 illustrates a schematic diagram of a small-capacity IMS core. The small-capacity IMS core system of the present invention is illustrated as being configured to include the MCU 110 configured to simply provide only functions that belong to the functions of the IMS structure and that are required for the group customer; the LIU 120 used to extend the physical ports of the POTS; the SIP gateway 130 configured to convert a standard SIP message into an IMS message; and the FMC controller 140 configured to support a wireless terminal, such as an IMS terminal/smartphone, so that it can be used in a mobile environment. In particular, the small-capacity IMS core system 100 is formed by including the IP communication-based back-plane 150 configured to enable the high-speed exchange of information between the individual units as a configuration for connecting the plurality of components. This back-plane 150 is implemented using a virtual Ethernet. Furthermore, information is enabled to be exchanged between units via the back-plane at a 10/100/1000 Mbps Ethernet speed, and thus signal transmission can be stably performed between the individual units.

Next, FIG. 4 is a diagram illustrating an example of the coupling configuration of the small-capacity IMS core system 100. The small-capacity IMS core system 100 is implemented as a 19-inch sub-rack system that can be mounted in a standard communication rack, and provides a dual power supply (AC, DC, and relay) function. That is, a power in the range from AC 110 to 230 V is input, and is supplied in the form of DC. In the case of a high DC voltage, voltages suitable for internal configurations, such as DC 12 V and DC 5 V, are supplied.

Furthermore, the sub-rack system provides slots into which 14 units can be mounted. For example, an SCU (signaling control unit) configured to provide the function of connecting an external network port to the back-plane is mounted into slot No. 0, and two MCUs are mounted into slots Nos. 1 and 2. A plurality of PSTN control units, a SIP gateway, and an FMC controller are mounted into the remaining 11 optional slots depending on a configuration environment required by a customer. When 11 or more optional slots are required, a plurality of sub-racks is connected using the system extension port of the SCU, and is then used as a single system.

FIG. 5 illustrates an example of the appearance of an embodiment of the small-capacity IMS core system 100. The small-capacity IMS core system 100 is implemented on a suitable scale depending on the use environment of a customer or a user based on a system installation space, 19-inch sub-rack systems having various sub-rack sizes may be constructed, and units used in each sub-rack system are the same as units used in the other sub-rack systems. In FIG. 5, a “system sub-rack” type system, a “half-rack” type system and a “mini-rack” type system are illustrated as examples. The “system sub-rack” type system enables a 19-inch standard rack to be mounted therein, and supports a 6U type and dual power supply. Furthermore, in the case of a 14 slot support type system, 4 system sub-racks are connected via a bus and a total of 56 slots are constructed. The “system sub-rack” type system is advantageously applied to a large medium enterprise or an enterprise having a large number of PSTN ports.

The “half-rack” type system enables 19-inch standard racks to be mounted therein, and supports a 4U type and dual power supply. The “half-rack” type system supports 5 slots, and can be used in a large medium enterprise in all-IP environment or a small or medium-sized enterprise having a small number of PSTN ports. Furthermore, the “mini-rack” type system enables 19-inch standard racks to be mounted therein, and may support a 2U type and 2 slots. The “mini-rack” type system is used in a small or medium-sized enterprise that does not require CPU duplication. As described above, a system having suitable specifications is used depending on the use environment of a user or a user customer.

FIG. 6 illustrates an example of the shape of the units of the small-capacity IMS core system 100. The small-capacity IMS core system 100 provides various interfaces physically connected to the outside according to the functions of individual units, and connects external various terminals so that they are connected thereto. For example, the SCU unit includes AC PWR, DC PWR, Restart, and LAN1 and LAN2 for external connections. The MCU unit includes POWER, REG., Restart, CON, WAN, and USB. Furthermore, the FMC unit includes POWER, REG., Restart, CON, two WANs and an USB, and a SIP-GW SIP gateway unit includes POWER, REG., Restart, CON, two WANs, and USB. In connection with the LIU, units, including LIU-E, LIU-O, LIU-S, and LIU-2S, are provided. The LIU-E unit includes two SYNCS, two LOSSes, and two ER RPIs, together with POWER, REG., Restart, CON, and WAN, the LIU-O unit includes POWER, REG., Restart, CON, WAN, LINE 1 to LINE 8, the LIU-S unit includes POWER, REG., Restart, CON, WAN, Tel1 to Tel8, and the LIU-2S unit includes POWER, REG., Restart, CON, WAN, and Tel1 to Tel16.

Next, the principal component units of the small-capacity IMS core system 100 are described.

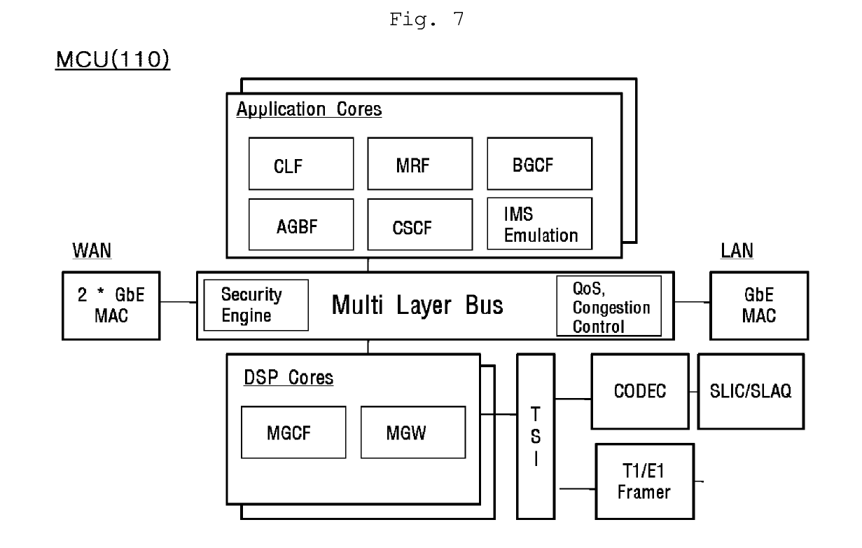

First, the MCU 110 is described using the preferred hierarchical diagram of FIG. 7 below. With regard to the purposes of a general MCU, the MCU 110 performs an IMS function via a CSCF (call session control function), an ABGF (access board gateway function) and an MGW (media gateway), and performs an SBC (session board controller) function. Furthermore, the MCU is implemented on a single board.

Furthermore, in the MCU, the hardware of an MGW (media gateway) function is configured such that one of FXO, FXS and E1/T1 PRI interfaces is selected and is replaced on a per-module basis according to the specifications of a wired telephone.

Furthermore, the MCU is provided with the function of determining a network bandwidth and a packet processing priority for each type of traffic and each port with respect to network traffic transferred to the MCU via the back-plane, thereby guaranteeing voice call quality.

Furthermore, the MCU is implemented to be provided with the function of inspecting network traffic received via a WAN port over the Internet or a network, detecting traffic recognized as a malicious attack packet with respect to the IMS core, and blocking the access of an IP terminal that transmits a detected corresponding packet that is determined to be malicious traffic. Accordingly, use secure from the malicious terminal is achieved.

Next, the MCU is implemented to implement the function of, with respect to network traffic received over a WAN, such as the Internet or a network, determining whether the traffic has been authorized by the IMS core, identifying an illegal access packet that attempts to appropriate an IMS service, and blocking the access of an IP terminal that transmits a corresponding packet.

Furthermore, two WAN ports are configured in the MCU using an active/stand-by method. Accordingly, when Internet access cannot be made because a network cable or a network switch connected to an active WAN port or an active WAN port fails, the network port duplication function of immediately accessing the Internet via a stand-by WAN port is provided.

Furthermore, when the MCU is duplicated using an active/stand-by method and also an active MCU fails, an MCU duplication function of providing a method of immediately switching a stand-by MCU to an active mode and switching an existing active MCU to stand-by mode is provided and so forth, thereby further ensuring the stability of the function of the MCU.

In the above MCU duplication function, all changes to settings, the registration information of a terminal and a call processing log generated in the active MCU are transferred to a stand-by main processing unit in real time, and thus the MCU duplication function in which switching between active mode and stand-by mode is securely performed in real time is provided.

Referring to the implementation of FIG. 7, the above-described MCU is configured to implement some of all of the functions that belong to the functions of the IMS structure and are used to accommodate a group customer, which are distributed and then performed among a plurality of CPU cores. The network ports of the MCU are divided into WAN ports and LAN ports, and voice/data packets are exchanged between the network ports and the CPU core via a multi-layer bus using an IP method. The multi-layer bus performs the security management and QoS/congestion management functions of the MCU in the OSI network layer or the data link layer in response to commands from a higher application core. The functions of application software running on each core follow the definitions of the respective functions of the IMS structure. The PSTN ports connected to the MCU are connected to the DSP core via a TSI (a TDM bus), an SLIC is a module used to connect an analog terminal, an SLAQ is a module used to connect an analog local loop, an T1/E1 framer is a module used to connect digital T1/E1 lines, and a CODEC is a device configured to convert an analog signal to a digital PCM.

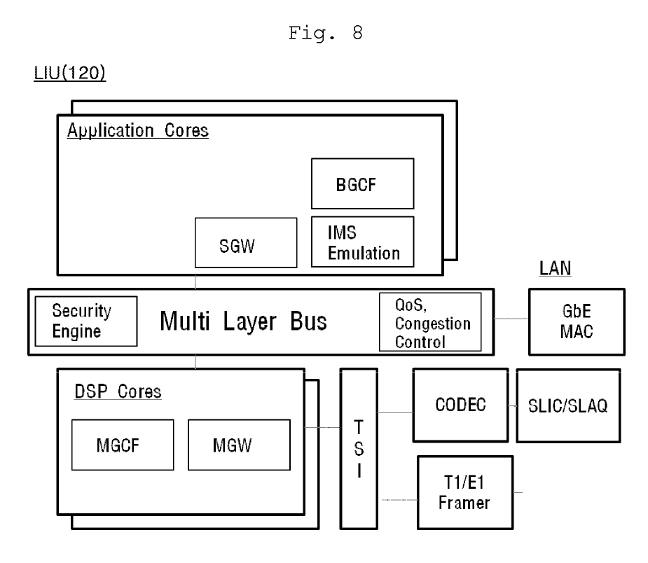

The LIU 120 is described with reference to FIG. 8 below.

The LIU 120 of the present invention provides an option board corresponding to each physical port in accordance with the characteristics of various PSTN physical ports to which exchanges, including an analog telephone, the public exchange of a telephone station and an ISDN exchange, are connected. As described above, the types of option boards mounted on the LIU is automatically recognized, and the LIU function of automatically switching to a corresponding set screen and function is provided.

Furthermore, the LIU connects IMS service numbers to respective PSTN ports, and thus allows an analog terminal connected to the PSTN port to be recognized as an IMS terminal by the CSCF of the IMS service provider, thereby supporting the LIU function of enabling the analog terminal to receive the same IMS service as an IMS dedicated terminal.

Furthermore, a private branch exchange or the local loop of a key phone system is connected to the PSTN analog port of the LIU, and the LIU function of providing support so that analog/digital terminals connected to a corresponding device share a single IMS service number is provided.

Furthermore, a private branch exchange or the local loop of a key phone system is connected to the ISDN digital port of the LIU, and the LIU function of providing support so that analog/digital terminals connected to a corresponding device share a plurality of IMS service numbers is provided.

Using an exchange, a key phone or the like connected to each port of the LIU as described above, even an analog terminal or digital terminal is provided with various IMS services, and, thus, is provided with a stable connection service with a terminal in another environment.

Furthermore, the public exchange of a telephone station is connected to the PSTN port of the LIU, and the LIU function of providing support so that various terminals connected to the IMS core directly make calls over the PSTN network and directly receive calls received over the PSTN network. Therefore, even a terminal connected to the public exchange is provided with stable service.

When the connection between the IMS core and the CSCF of an IMS service provider is released because of a problem, such as an Internet failure or a network failure, the backup function of automatically detouring an originating call of a terminal, connected to the IMS core, to the PSTN network is provided. Accordingly, a function is provided such that use is not hindered by a situation in which a connection is released.

As a specific example of the LIU, FIG. 8 illustrates the hierarchical structure of the LIU 120.

The LIU is configured to implement some or all of the functions that that belong to the functions of the IMS structure and that are required for cooperative operation with the PSTN, which are distributed and then performed among a plurality of CPU cores. The network port of the LIU is connected to the backbone plane, and a voice packet and a control message are exchanged between the network ports and the CPU core via a multi-layer bus using an IP method. The multi-layer bus performs the security management function of the MCU in the OSI network layer or the data link layer in response to commands from a higher application core. The functions of application software running on each core follow the definitions of the respective functions of the IMS structure. The PSTN ports connected to the LIU are connected to the DSP core via a TSI (a TDM bus), an SLIC is a module used to connect an analog terminal, an SLAQ is a module used to connect an analog local loop, an T1/E1 framer is a module used to connect digital T1/E1 lines, and a CODEC is a device configured to convert an analog signal to a digital PCM.

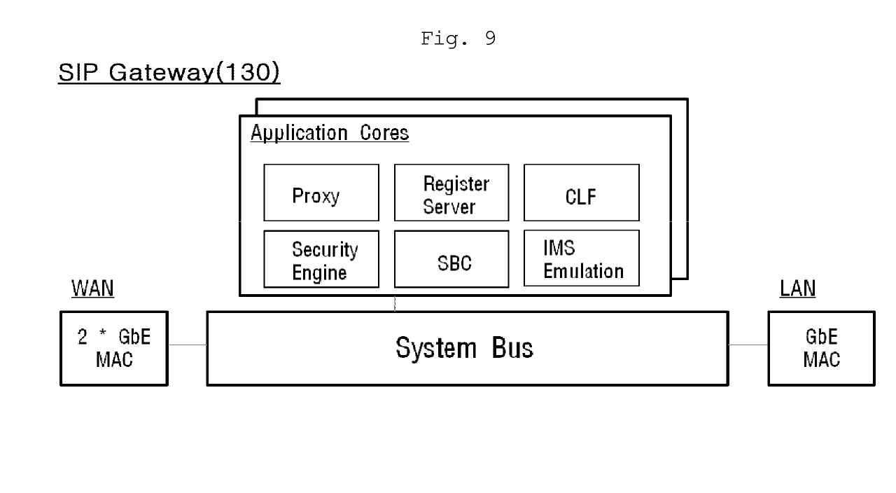

The SIP gateway 130 is described with reference to FIG. 9 below.

The SIP gateway provides the SIP gateway function of receiving a SIP message from a terminal using the SIP protocol, such as a SIP phone, a soft phone, a WiFi phone or a DECT phone, converting the SIP message into an IMS message and transmitting the IMP message to the MCU, and converting an IMS message, received from the MCU, into a SIP message and transmitting the IMS message to a SIP terminal. Accordingly, even users who use SIP terminals can use an IMS service without suffering from inconvenience.

Furthermore, the SIP gateway enables a single SIP terminal or a plurality of SIP terminals to operate in cooperation with a single IMS service number, thereby providing support so that a plurality of SIP terminals shares a single IMS service number.

Furthermore, the SIP gateway provides a configuration for a head office/branch to an IP-PBX or a media gateway using the SIP protocol, thereby providing the function of supporting direct communication between individual devices using exchange extension numbers. Accordingly, the terminal of a head office/branch can be easily used with respect to an IP-PBX and a media gateway without suffering from inconvenience using an extension use method.

FIG. 9 illustrates the hierarchical structure of the SIP gateway 130. The SIP gateway is implemented to provide an IP-PBX function in accordance with a standard SIP terminal and to provide the function of the IMS terminal in accordance with the CSCF of the MCU 110, and the functions are distributed and then performed among a plurality of CPU cores. The network ports of the SIP gateway are divided into a WAN port and a LAN port, and data packets are exchanged between the individual network ports and the CPU core via the system bus using an IP method. A standard SIP terminal connects to the WAN port or the LAN port depending on the location where the terminal has been installed, is registered with the register server of the application core, and call processing control and the transfer of an RTP packet are performed via a proxy. In order to perform communication with the IMS terminal or the use of the IMS service, it is necessary to convert a standard SIP message into an IMS message via an IMS emulation module, to be assigned a predefined IMS terminal number, and to operate in cooperation with the CSCF of the main processing unit 110. Communication between SIP terminals connected to the SIP gateway is performed using private extension numbers by means of an SIP method.

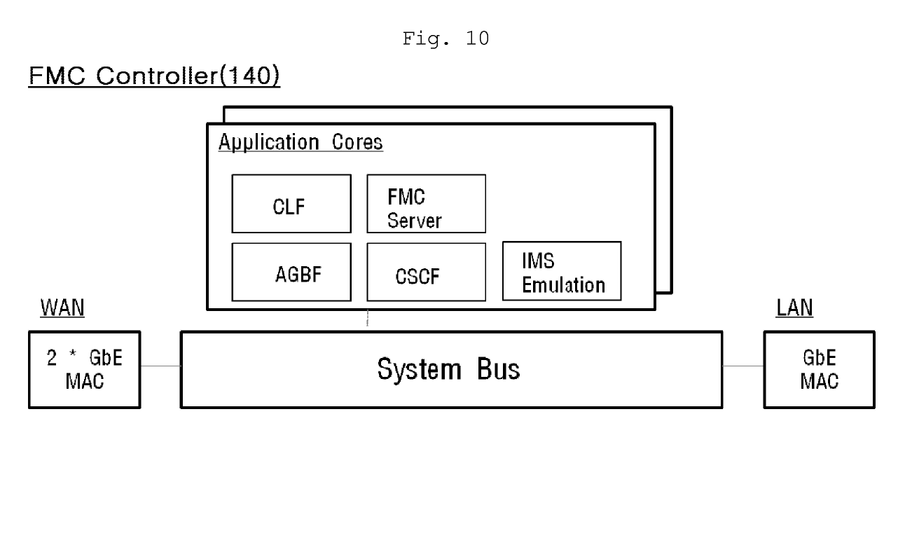

The FMC controller 140 is described with reference to FIG. 10.

When the IMS service is used in an environment in which terminals, such as a WiFi phone, a DECT phone and a smartphone (a soft phone), move, the FMC controller keeps track of the IP addresses and port numbers of the terminals in real time, a terminal information DB is updated, and thus the connection of the corresponding terminals is smoothly performed. In particular, the FMC controller function of providing the additional function of, when a telephone call is made using a telephone call communication application (a soft phone application, or a telephone call application) installed on a corresponding terminal, such as a smartphone, automatically activating telephone call communication application (a soft phone app, or a telephone call app) in a terminal in standby state upon receiving a telephone call is provided. Accordingly, two terminals in which the corresponding app has been installed smoothly make a telephone call, in which case the corresponding terminals are provided with telephone calls, as if internal telephones were used because the FMC controller keeps track of and makes an update with changes to IP addresses and port numbers.

Furthermore, the FMC controller provides the SBC (session boarder controller) function of maintaining a session and supporting call processing even when mobile terminals access the FMC controller via a plurality of IP routers.

FIG. 10 illustrates the hierarchical structure of the FMC controller 140. The FMC controller is implemented to provide the function of the IMS terminal in accordance with the CSCF of the MCU 110 and to provide the CSCF function in accordance with the IMS terminal in a mobile communication environment, and these function are distributed and then performed among a plurality of CPU cores. The network ports of the FMC controller are divided into a WAN port and a LAN port, data packets are exchanged between the individual network ports and the CPU core via a system bus using an IP method. The IMS terminal accesses the WAN port and is connected to the CSCF of the application core, and the LAN port is used when the FMC controller communicates with the MCU 110. The FMC server module provides the function of processing roaming between wireless APs and roaming between a 3G/4G mobile communication data network and a wireless AP so that the IMS terminal can be used while moving. When an IMS terminal is implemented using a telephone call communication application (a soft phone app, a telephone call app, or the like) installed on a portable terminal (smartphone or the like), the FMC server module provides the additional function of transmitting an IMS message using a TCP method or transmitting an activation message, such as a soft phone app, in order to activate a telephone call communication application (a soft phone, a telephone call app, or the like) whenever a telephone call is received at a reception terminal. Since the communication between the IMS terminals connected to the FMC controller uses the IMS service numbers, the CSCF of the IMS service provider and the AS (application server) should be used.

Furthermore, it is preferable that any one of or all of the MCU, the LIU, the SIP gateway and the FMC controller are implemented using a plurality of CPU cores. Furthermore, a corresponding function is assigned to each of the cores and then implemented, and communication is performed between software modules using a message exchange method because software is modularized for individual functions. Accordingly, the convenience of the modification of the functions and additional work is increased. These individual functions are distributed and then performed among separate pieces of independent hardware, and the use thereof is sufficiently enabled even when the scale of the use of a customer or user is extended, thereby flexibly dealing with the use of the user.

In accordance with the small-capacity IMS core system 100 according to the present invention provided as described above, the IMS service is constructed for a group customer (an enterprise, an organization, a school or the like), such as an enterprise having 1,000 or less employees or a small-sized multimedia service provider, and thus advantages arise in that telephone connection via an IMS phone, a SIP phone and a PSTN and individual terminals are used as extension telephones or are organized into a multimedia system even in a mobile communication environment.

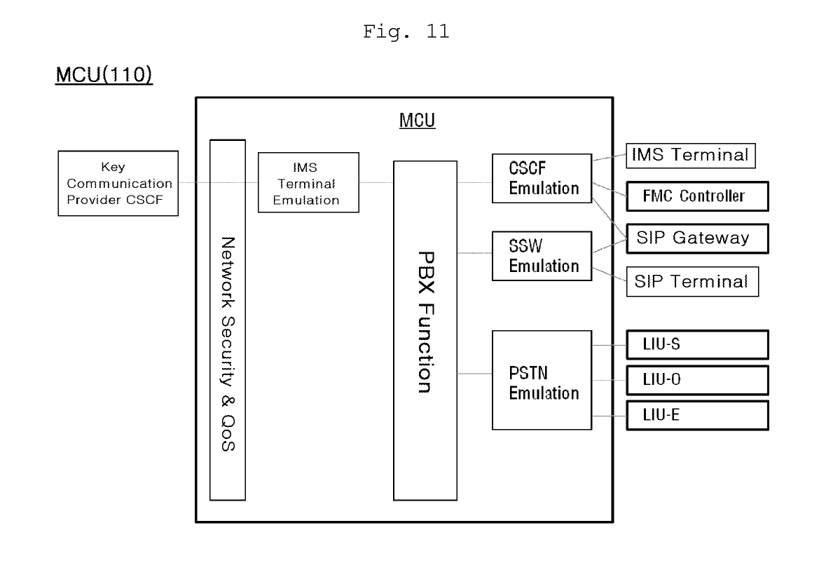

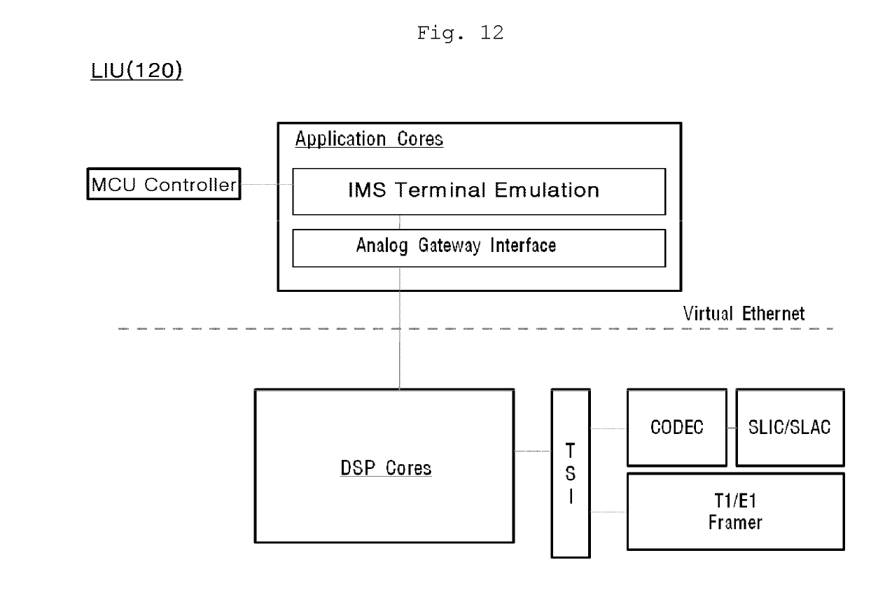

The key functions of the small-capacity IMS core system of the present invention having the above-described configuration are described with reference to the corresponding drawings, with a focus on the configurations illustrated in FIGS. 3 to 10 and the functions of the MCU, the LIU, the SIP gateway, and the FMC controller of FIGS. 11 to 14.

The MCU performs previous settings, and thus a user may select the IMS or the PSTN and make a call. That is, as illustrated in FIG. 11, when an IMS service call is input to the MCU via an external key communication service provider (for example, the CSCF of the IMS service provider), the call passes through a network security & QoS, and an IMS terminal emulation makes a response using an IMS number (for example, a telephone number) corresponding to the call. The received call is transmitted to an internal terminal corresponding to the corresponding IMS number via a PBX function. If this internal terminal is an IMS terminal, the received call is transmitted to the IMS terminal or the FMC controller via the CSCF emulation. If the internal terminal is a SIP terminal, the received call is transmitted to the SIP terminal via the SSW emulation. If the internal terminal is a PSTN terminal, the received call is transmitted to the PSTN terminal via the PSTN emulation. In contrast, in order for a user to send a call, when a preset terminal sends an originating signal to the present IMS core via the IMS or the PSTN, a corresponding unit receives the signal, and the control unit transmits an originating signal to the outside (via a service network provider) via the IMS or the PSTN.

This method assigns a virtual IMS extension number to an internal terminal connected to the IMS core system of the present invention, and enables the receiving/originating call to be processed while connecting the IMS number of an IMS service provider defined by the IMS emulation with a virtual IMS extension number. Accordingly, the IMS core of the present invention performs the private branch exchange function of an enterprise.

Furthermore, the IMS core system of the present invention includes the LIU, the SIP gateway and the FMC controller and, thus, enables an existing wired telephone network and a SIP telephone to be used, a detour to the PSTN is made when the IMS service fails and a detour to the IMS is made when the PSTN fails, thereby making a call. Since the IMS emulation periodically exchanges a registration signal with the CSCF system of the IMS service provider, a call transmitted to the outside is detoured to a PSTN local loop when an IMS service registration state is released because of a network failure. Since the PSTN emulation always monitors the connection state of the PSTN local loop, a call to be transmitted to the PSTN local loop is detoured to the IMS service network when the connection of the PSTN local loop is released for a reason, such as the cutting of a transmission line.

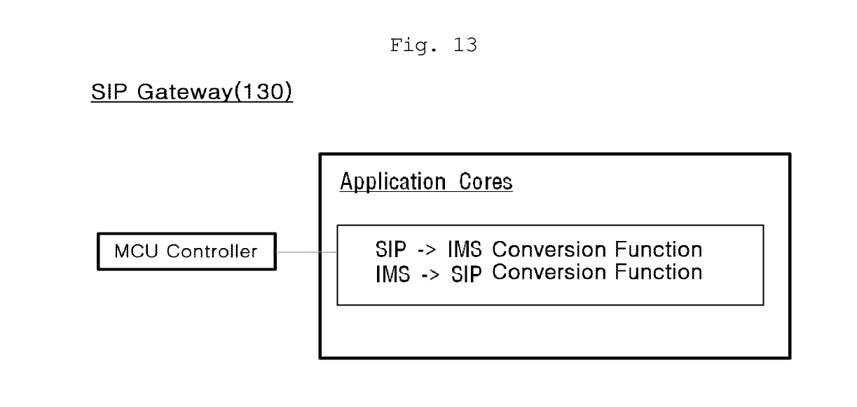

Furthermore, extension numbers are assigned to external IMS terminals or SIP terminals using private IP addresses, and thus the general wired and wireless Internet networks are used between extension terminals and an additional communication provider network is not used, thereby enabling calls or SMS service to be used without incurring additional communication charge. Furthermore, the SIP gateway performs protocol conversion, thereby performing the conversion function of SIP->IMS conversion and IMS->SIP, as illustrated in FIG. 13, so that a standard SIP terminal can be used without the additional conversion of firmware or software. That is, the function of protocol converter between SIP and IMS is provided to allow an existing SIP terminal to be used.

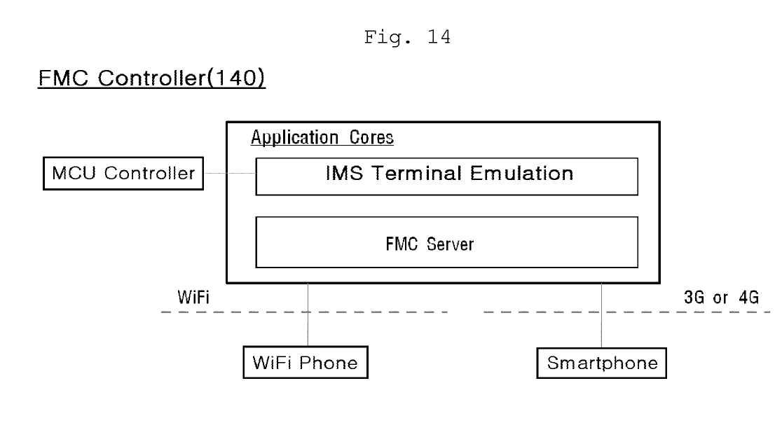

The FMC controller provides voice roaming between a wireless LAN network and a 3G/4G network using an FMC-controller function, as illustrated in FIG. 14, thereby supporting Mobile-VoIP for phones including a Wifi phone and a smartphone.

Additionally, the IMS core system provides an API that allows cooperative operation with Smart Work, CRM and UC.

Although the embodiments of the present invention have been described in detail below, the embodiments have been described merely to enable those having ordinary knowledge in the field of art to which the present invention pertains to easily practice the present invention, and thus the technical spirit of the present invention should not be limited by the description of the embodiments.

### INDUSTRIAL APPLICABILITY

The present invention provides a system that is used in the field that provides support in order to enable a group customer (an enterprise, an organization, a school or the like) using an IMS service, called a small-capacity IMS core, to internally use a POTS system and an Internet telephone system in parallel and to enable an non-IMS terminal, such as a wired/wireless IP telephone, or a smartphone, to be used along with an IMS terminal.

1. An IMS core system, comprising:
a main control unit (MCU) configured as a terminal device that uses services while operating in cooperation with an IMS service provider network including an Internet telephony network and an IPTV network, and configured to include an IMS core, including a CSCF, an MGW and an ABGF, and a function of an IMS terminal; and
a back-plane configured to detect an Internet speed and a half/full duplex mode for each slot, and to perform exchange of information between units, including the MCU, using a non-blocking method.

2. An IMS core system comprising:
a main control unit (MCU) configured as a terminal device that uses services while operating in cooperation with an IMS service provider network including an Internet telephony network and an IPTV network, and configured to include an IMS core including a CSCF, an MGW and an ABGF, and a function of an IMS terminal;
the IMS core system further comprising any one of:
an line interface unit (LIU) configured to include ports that enable cooperative operation with a POTS system including T1/E1 PRI, FXO and FXS;
an SIP gateway configured to include a protocol conversion function in order to enable an SIP terminal, including a SIP phone, a soft phone, a WiFi phone and a DECT phone, to operate in cooperation with an IMS apparatus; and
an FMC controller configured to include a roaming function for enabling an IMS service to be used in a mobile environment, and to include an IP address synchronization function of a mobile terminal.

3. The IMS core system of claim 2, wherein:
units, including the MCU, the LIU, the SIP gateway and the FMC controller, are provided; and
IP communication is performed between the units;
the IMS core system further comprising:
a control bus configured to detect attachment and detachment of each of the units, and to control operations of the respective units;
an IO interface configured to provide sub-rack information and slot address information as information about locations at which the respective units have been attached; and
a back-plane configured to automatically detect an Internet speed and a duplex mode for each slot, and to enable exchange of information between the units, including the MCU, the LIU, the SIP gateway and the FMC controller, using a non-blocking method.

4. (canceled)

5. (canceled)

6. The IMS core system of claim 3, wherein:
each of the units:
performs an automatic opening process of, once the unit has been inserted into a slot of a system and also booting has been completed, reading information about a location of the slot from the back-plane, automatically setting an IP address of the unit, and configuring a network; connects to the MCU, compares a firmware version stored in storage of the MCU with its own firmware version, and performs an automatic upgrade to the firmware stored in the MCU if the firmware versions are different from each other; and performs an automatic upgrade process of reading its own detailed configuration information from a DB of the MCU and performing an automatic function setting procedure.

7. The IMS core system of claim 2, wherein the LIU is provided to associate an IMS service number with each PSTN port, so that an analog terminal connected to the PSTN port is recognized as an IMS terminal by a CSCF of an IMS service provider and, thus, the analog terminal performs an IMS service in a same manner as an IMS dedicated terminal.

8-11. (canceled)

12. The IMS core system of claim 2, wherein the MCU comprises:
IMS functions including a CSCF (Call Session Control Function), an ABGF (Access Board Gateway Function), and an MGW (Media Gateway); and
an SBC (Session Board Controller) function;
wherein the MCU is implemented using a single board.

13. The IMS core system of claim 2, wherein the MCU includes hardware that can be replaced on a per-module basis in such a manner that, in a case of an MGW (media gateway) function, an FXO, FXS, or E1/T1 PRI interface is selected in accordance with wired telephone specifications.

14-18. (canceled)

19. The IMS core system of claim 2, wherein the SIP gateway receives a SIP message from a terminal using an SIP protocol of a phone, including a SIP phone, a soft phone, a WiFi phone and a DECT phone, converts the SIP message into an IMS message, and transmits the IMS message to the MCU; and converts an IMS message received from the MCU into a SIP message, and transmits the SIP message to an SIP terminal.

20. The IMS core system of claim 2, wherein the SIP gateway associates a single IMS service number with one SIP terminal or a plurality of SIP terminals, so that the plurality of SIP terminals share the single IMS service number.

21. The IMS core system of claim 2, wherein the SIP gateway supports an IP-PBX or media gateway and a head office/branch configuration using an SIP protocol, thereby providing support to enable devices to perform direct communication using exchange extension numbers.

22-24. (canceled)

25. The IMS core system of claim 3, wherein the LIU is provided to associate an IMS service number with each PSTN port, so that an analog terminal connected to the PSTN port is recognized as an IMS terminal by a CSCF of an IMS service provider and, thus, the analog terminal performs an IMS service in a same manner as an IMS dedicated terminal.

26. The IMS core system of claim 3, wherein the MCU comprises:
IMS functions including a CSCF (Call Session Control Function), an ABGF (Access Board Gateway Function), and an MGW (Media Gateway); and
an SBC (Session Board Controller) function;
wherein the MCU is implemented using a single board.

27. The IMS core system of claim 3, wherein the MCU includes hardware that can be replaced on a per-module basis in such a manner that, in a case of an MGW (media gateway) function, an FXO, FXS, or E1/T1 PRI interface is selected in accordance with wired telephone specifications.

28. The IMS core system of claim 3, wherein the SIP gateway receives a SIP message from a terminal using an SIP protocol of a phone, including a SIP phone, a soft phone, a WiFi phone and a DECT phone, converts the SIP message into an IMS message, and transmits the IMS message to the MCU; and converts an IMS message received from the MCU into a SIP message, and transmits the SIP message to an SIP terminal.

29. The IMS core system of claim 4, wherein the LIU is provided to associate an IMS service number with each PSTN port, so that an analog terminal connected to the PSTN port is recognized as an IMS terminal by a CSCF of an IMS service provider and, thus, the analog terminal performs an IMS service in a same manner as an IMS dedicated terminal.

30. The IMS core system of claim 4, wherein the MCU comprises:
IMS functions including a CSCF (Call Session Control Function), an ABGF (Access Board Gateway Function), and an MGW (Media Gateway); and
an SBC (Session Board Controller) function;
wherein the MCU is implemented using a single board.

31. The IMS core system of claim 4, wherein the MCU includes hardware that can be replaced on a per-module basis in such a manner that, in a case of an MGW (media gateway) function, an FXO, FXS, or E1/T1 PRI interface is selected in accordance with wired telephone specifications.

32. The IMS core system of claim 4, wherein the SIP gateway receives a SIP message from a terminal using an SIP protocol of a phone, including a SIP phone, a soft phone, a WiFi phone and a DECT phone, converts the SIP message into an IMS message, and transmits the IMS message to the MCU; and converts an IMS message received from the MCU into a SIP message, and transmits the SIP message to an SIP terminal.

33. The IMS core system of claim 2,
wherein the MCU comprises: IMS functions including a CSCF (Call Session Control Function), an ABGF (Access Board Gateway Function), and an MGW (Media Gateway); and an SBC (Session Board Controller) function;
wherein the MCU includes hardware that can be replaced on a per-module basis in such a manner that, in a case of an MGW (media gateway) function, an FXO, FXS, or E1/T1 PRI interface is selected in accordance with wired telephone specifications,
wherein the LIU is provided to associate an IMS service number with each PSTN port, so that an analog terminal connected to the PSTN port is recognized as an IMS terminal by a CSCF of an IMS service provider and, thus, the analog terminal performs an IMS service in a same manner as an IMS dedicated terminal,
wherein the SIP gateway receives a SIP message from a terminal using an SIP protocol of a phone, including a SIP phone, a soft phone, a WiFi phone and a DECT phone, converts the SIP message into an IMS message, and transmits the IMS message to the MCU; and converts an IMS message received from the MCU into a SIP message, and transmits the SIP message to an SIP terminal, and
wherein the SIP gateway associates a single IMS service number with one SIP terminal or a plurality of SIP terminals, so that the plurality of SIP terminals share the single IMS service number.

34. The IMS core system of claim 3,
wherein the MCU comprises: IMS functions including a CSCF (Call Session Control Function), an ABGF (Access Board Gateway Function), and an MGW (Media Gateway); and an SBC (Session Board Controller) function;
wherein the MCU includes hardware that can be replaced on a per-module basis in such a manner that, in a case of an MGW (media gateway) function, an FXO, FXS, or E1/T1 PRI interface is selected in accordance with wired telephone specifications,
wherein the LIU is provided to associate an IMS service number with each PSTN port, so that an analog terminal connected to the PSTN port is recognized as an IMS terminal by a CSCF of an IMS service provider and, thus, the analog terminal performs an IMS service in a same manner as an IMS dedicated terminal,
wherein the SIP gateway receives a SIP message from a terminal using an SIP protocol of a phone, including a SIP phone, a soft phone, a WiFi phone and a DECT phone, converts the SIP message into an IMS message, and transmits the IMS message to the MCU; and converts an IMS message received from the MCU into a SIP message, and transmits the SIP message to an SIP terminal, and
wherein the SIP gateway associates a single IMS service number with one SIP terminal or a plurality of SIP terminals, so that the plurality of SIP terminals share the single IMS service number.
